(19) United States
(12) Patent Application Publication
(10) Pub. No.: US 2019/0124239 A1
(43) Pub. Date: Apr. 25, 2019

(54) ON-VEHICLE PHOTOGRAPHING DEVICE

(71) Applicant: YAZAKI CORPORATION, Tokyo (JP)

(72) Inventors: Kentaro Otomo, Shizuoka (JP); Hiroki Kojima, Shizuoka (JP)

(21) Appl. No.: 16/127,122

(22) Filed: Sep. 10, 2018

(30) Foreign Application Priority Data
Oct. 23, 2017 (JP) 2017-204691

(51) Int. Cl. H04N 5/225; B60R 11/04; B60K 35/00

(52) U.S. Cl. CPC H04N 5/2256; B60R 11/04; G03B 15/03; B60K 2350/2013; B60K 35/00

(57) ABSTRACT

The present invention provides an on-vehicle photographing device. A monitoring camera is installed inside a common area that is made common to the display area of an indicator display section for displaying the states of the vehicle, such as direction indication, as viewed from the position corresponding to the viewpoint of the driver of the vehicle. Since the monitoring camera is assimilated with the area of the indicator display section and becomes less conspicuous, the driver is deluded and unaware of the existence of the monitoring camera. The monitoring camera and the indicator display section are entirely covered integrally or continuously with a film or the like, and this entire structure is configured so as to be recognized by the driver as a common indicator area. Infrared illumination sections are provided and the monitoring camera performs photographing using the light having wavelengths in the infrared light wavelength region.

### CROSS-REFERENCES TO RELATED APPLICATIONS

This application is a based on and claims priority from Japanese Patent Applications No. 2017-204691 filed on Oct. 23, 2017, the entire contest of which are incorporated herein by reference.

### BACKGROUND OF THE INVENTION

### 1. Technical Field

The present invention relates to an on-vehicle photographing device installed inside a vehicle and including a monitoring camera disposed in a state of being capable of photographing at least the face of the driver in the vehicle.

### 2. Background Art

Patent Document 1, for example, discloses a technology for providing a “display device” incorporating an imaging device without degrading design and appearance.

Furthermore, as disclosed in Patent Document 1, in a vehicle equipped with a driver monitoring system, a camera unit is installed behind the steering wheel as viewed from the driver, and the camera unit photographs the states of the eyes and eyelids of the driver, whereby the system detects a drowsing state of the driver according to image data. A meter panel equipped with meters, such as a speed meter, is installed in front of the driver, and a dedicated camera unit is installed at the lower portion of the meter panel. The camera unit incorporates an imaging device and a plurality of LED light sources emitting infrared rays so that the face of the driver can be photographed securely even at night.

Moreover, Patent Document 1 also discloses a configuration in which a camera and LEDs for emitting infrared light are installed on the rear side of a liquid crystal display panel.

Patent Document 1: JP-A-2014-31140

### SUMMARY OF THE INVENTION

In a vehicle such as an automobile, for example, in the following cases (1) to (3), it is necessary to detect the state of the driver in real time by photographing the face of the driver during vehicle operation and to record and store photographed image data.

(1) In the case of detecting a drowsing state of the driver

(2) In the case of detecting whether the driver is performing left-right confirmation for safe driving

(3) In the case of requiring recorded data representing the state of the driver at the time of the occurrence of a traffic accident

Hence, as disclosed, for example, in Patent Document 1, it is necessary to photograph the face of the driver from the front using a camera mounted on a vehicle. However, since this kind of camera is usually disposed in front of the driver in a state of being visually recognizable by the driver, the driver becomes aware of the existence of the camera. For this reason, in the case that the driver works as a driver of a truck, a bus or the like belonging to and being managed by a company or the like, even in a state in which the driver is not monitored actually, the driver recognizes that he or she is always monitored during driving by others using the camera. Thus, the driver worries about the monitoring, whereby there may be cases in which the driver cannot concentrate on driving operation and it becomes difficult to secure safe driving.

As in Patent Document 1 for example, in the case that the camera or the like is installed on the rear side of the liquid crystal display panel, the above-mentioned problem hardly occurs because the driver cannot visually recognize the existence of the camera from the viewpoint position of the driver. However, since the technology of Patent Document 1 is supposed to use the liquid crystal display panel, the structure of the monitoring system is complicated, and there is a concern about increase in cost. Still further, the camera cannot be installed at a location where the liquid crystal display panel is not used.

The present invention has been made in consideration of the above-mentioned circumferences, and the object of the present invention is to provide an on-vehicle photographing device wherein a camera for monitoring the driver of a vehicle can be installed in a state in which the driver is unlikely to be aware of the existence of the camera, without adopting a complicated structure.

To attain the above-mentioned object, an on-vehicle photographing device according to the present invention is characterized as described in the following items (1) to (3).

(1) An on-vehicle photographing device including a monitoring infrared camera installed inside a vehicle and disposed in a state of being capable of photographing a face of a driver in the vehicle, wherein

the monitoring infrared camera is installed inside a common area that is made common to a display area of an indicator which displays a state of the vehicle as viewed from at least a position corresponding to a viewpoint of the driver in the vehicle, and

the monitoring infrared camera is covered with a visible light cutting member.

With the on-vehicle photographing device configured as described in the above-mentioned item (1), since the monitoring camera is installed inside the common area, the driver deludingly recognizes that the installation portion of the monitoring camera is a portion of the display area of the indicator. Hence, the driver is unlikely to notice that the monitoring camera is installed. In other words, the camera is assimilated with the indicator, whereby the driver is unlikely to receive a feeling of psychological oppression.

(2) The on-vehicle photographing device set forth in the above-mentioned item (1), wherein

in the common area, the monitoring infrared camera and one or more of the indicators are covered with a common film or a common thin plate-like light-conducting member integrally or continuously.

With the on-vehicle photographing device configured as described in the above-mentioned item (2), the film or the thin plate-like light-conducting member exists in front of the monitoring camera and the indicator, and the common light-conducting member covers the monitoring camera and the indicator integrally or continuously. Hence, the driver deludingly recognizes that the entire common area covered with the light-conducting member is the area of the indicators having the same function, whereby the driver is unlikely to notice that the monitoring camera is installed.

(3) The on-vehicle photographing device set forth in the above-mentioned item (2), wherein

the visible light cutting member constitutes a portion of the area of the common film or the common thin plate-like light-conducting member.

With the on-vehicle photographing device configured as described in the above-mentioned item (3), since the entire display area of the indicator is visually recognized by the driver as one unified area, the driver is unlikely to be aware of the existence of the monitoring camera.

According to the on-vehicle photographing device in the present invention, a camera for monitoring the driver can be installed in a state in which the driver is unlikely to be aware of the existence of the camera, without adopting a complicated structure. Hence, the driver can concentrate on driving operation without being aware of the existence of the camera, whereby it becomes easy to secure safe driving.

The present invention has been described above briefly. Moreover, the details of the present invention will be further clarified by reading the descriptions of the modes (hereafter referred to as “embodiments”) for embodying the invention to be described below referring to the accompanying drawings.

### BRIEF DESCRIPTION OF THE DRAWINGS

FIG. 1 is a front view showing a meter unit including an on-vehicle photographing device according to an embodiment of the present invention;

FIG. 2 is an exploded perspective view showing a configuration example of a indicator display section of the meter unit shown in FIG. 1;

FIG. 3 is an exploded top view showing the indicator display section;

FIG. 4 is a perspective view showing the positional relationship between a meter board and an indicator board;

FIG. 5 is a side view showing the positional relationship between the on-vehicle photographing device and the driver of a vehicle;

FIG. 6 is a perspective view showing a configuration example in the case that a camera board independent of the indicator board is provided;

FIG. 7 is a side view showing the positional relationship between the on-vehicle photographing device and the driver in the case that the camera board independent of the indicator board is provided;

FIG. 8 is a perspective view showing a configuration example in the case that the indicator board is integrated with the meter board; and

FIG. 9 is a perspective view showing a configuration example in the case that a visible light cutting filter is integrated with an indicator film.

### DETAILED DESCRIPTION OF THE EXEMPLARY EMBODIMENTS

Specific embodiments according to the present invention will be described below referring to the accompanying drawings.

### <A Configuration Example of a Meter Unit>

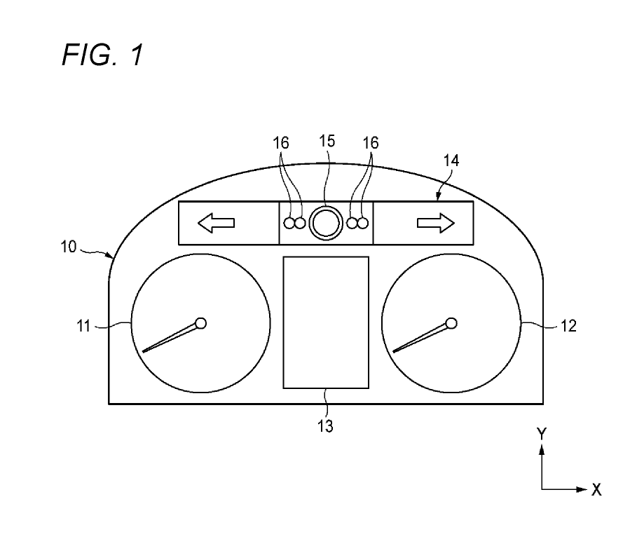

FIG. 1 shows a specific example of a meter unit 10 including an on-vehicle photographing device according to an embodiment of the present invention, as viewed from the driver side. The meter unit 10 shown in FIG. 1 is mounted on a vehicle and disposed at the front position of the driver sitting on the driver's seat of this vehicle in a state of being easily visually recognized by the driver. The directions of the X-axis and the Y-axis in FIG. 1 correspond to the left-right direction and the up-down direction of the vehicle, respectively.

The meter unit 10 shown in FIG. 1 is equipped with a left meter display section 11, a right meter display section 12, a central display section 13, and an indicator display section 14 as main components.

The left meter display section 11 and the right meter display section 12 are used to display a vehicle speed meter (speedometer) and an engine rotation meter (tachometer), respectively. Each of the speed meter and the engine rotation meter mounted on the meter unit 10 may be a mechanical meter having a physically movable pointer or may be an electronic meter that represents required information obtained by controlling visible information displayed on a display.

The central display section 13 is disposed at the central portion between the left meter display section 11 and the right meter display section 12. The central display section 13 is composed of a display or a plurality of lamps. The central display section 13 displays the states of the vehicle, such as the shift state of the automatic transmission, the on/off state of the parking brake, the lighting state of the head lights, and the lighting state of the vehicle width lamps.

The indicator display section 14 is disposed as an area having a slender rectangular shape on the upper sides of the left meter display section 11, the central display section 13 and the right meter display section 12. The indicator display section 14 is an area that is usually used to display indicators. As a typical example, indicators respectively representing the operation states of the left and right direction indicating devices of the vehicle are disposed inside the indicator display section 14.

In the example shown in FIG. 1, a camera 15 and infrared illumination sections 16 are disposed at the positions inside the same area as that of the indicator display section 14 as viewed from the viewpoint position of the driver. The camera 15 is installed in a state in which the photographing direction thereof is directed toward the face of the driver and the photographing range thereof has been adjusted so as to be able to detect the face direction and the sight line direction of the driver. The camera 15 has detection characteristics capable of photographing the light having wavelengths in the infrared light wavelength region. The infrared illumination sections 16 are composed of a plurality of LED devices emitting light in the infrared light wavelength region. The respective LED devices of the infrared illumination sections 16 are provided in a state in which the optical axes thereof are adjusted so as to be able to illuminate the face of the driver.

### <A Configuration Example of the Indicator Display Section 14>

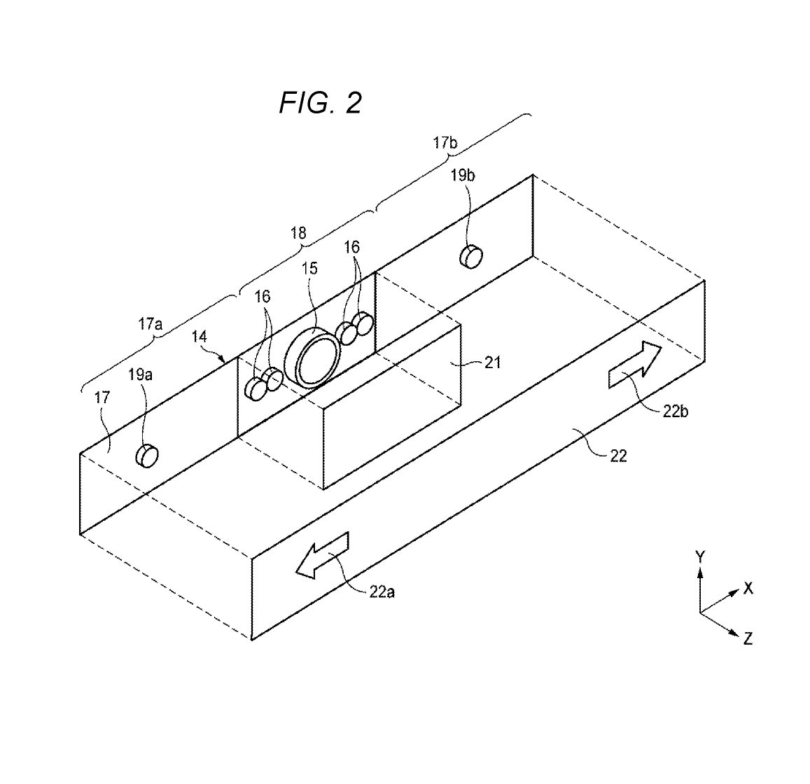

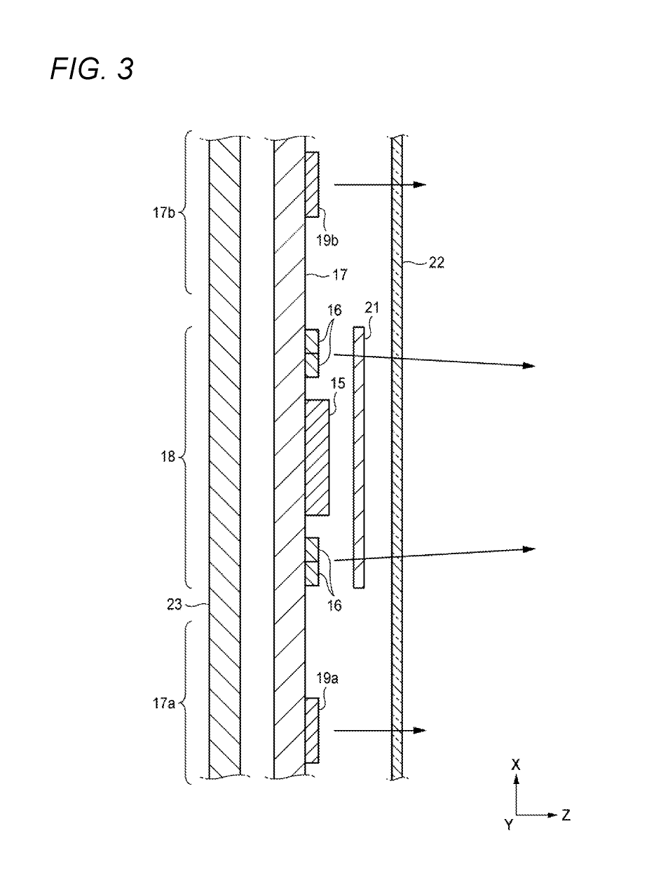

FIG. 2 is an exploded perspective view showing the main components of the indicator display section 14 of the meter unit 10 shown in FIG. 1, and FIG. 3 is an exploded top view showing the main components. Each of the Z-axes in FIGS. 2 and 3 corresponds to the direction directed from the meter unit 10 to the face of the driver. Furthermore, the directions of the X-axis and the Y-axis in FIGS. 2 and 3 correspond to the left-right direction and the up-down direction of the vehicle, respectively, as in FIG. 1.

In the example shown in FIG. 2, the main body 14 of the indicator display section 14 is composed of an indicator board 17. This indicator board 17 is a thin plate-like circuit board formed into a slender rectangular shape and has a left side area 17a and a right side area 17b in which the circuit components for the indicators are disposed.

In the example shown in FIG. 2, an indicator light source 19a for illuminating the leftward arrow-shaped area 22a formed on an indicator film 22 described later is installed in the left side area 17a of the indicator board 17. In addition, an indicator light source 19b for illuminating the rightward arrow-shaped area 22b formed on the indicator film 22 is installed in the right side area 17b of the indicator board 17. In other words, the indicator light source 19a is an indicator light source that informs the driver that the left winker indicating the left turn operation of the vehicle is lighting, and the indicator light source 19b is an indicator light source that informs the driver that the right winker indicating the right turn operation of the vehicle is lighting. Each of the indicator light sources 19a and 19b is composed of, for example, an LED (light-emitting diode) installed on the indicator board 17. The light emission of the LED enables the driver to visually recognize an arrow-shaped display pattern.

In the example shown in FIG. 2, the central portion between the left side area 17a and the right side area 17b of the indicator board 17 is allocated as an imaging section 18. This imaging section 18 is an area that is used to install the camera 15 and the infrared illumination sections 16 shown in FIG. 1 and has circuit patterns for connecting the respective circuits of the camera 15 and the infrared illumination sections 16 to predetermined on-vehicle devices. Since the imaging section 18 is integrated with the indicator board 17 in the example shown in FIG. 2, the circuit patterns of the imaging section 18 are formed on part of the surface of the indicator board 17.

As shown in FIGS. 2 and 3, a visible light cutting filter 21 is disposed on the front sides (in the forward direction of the Z-axis) of the camera 15 and the infrared illumination sections 16. This visible light cutting filter 21 is a thin plate-like optical component formed into a rectangular shape so as to cover the entire surfaces of the camera 15 and the infrared illumination sections 16 and has characteristics of shutting off the passage of the light in the visible light wavelength region and allowing the light in the infrared light wavelength region to pass through. The visible light cutting filter 21 may be disposed so as to cover only the light receiving face of the camera 15.

Furthermore, the indicator film 22 is disposed on the front side of the visible light cutting filter 21 so as to cover the entire indicator board 17. The indicator film 22 has a size equivalent to that of the indicator board 17 and is formed into a rectangular shape similar to that of the indicator board 17, for example.

Moreover, the indicator film 22 is made of a film material that is uniformly pale-colored for example so that the entire indicator display section 14 is visually recognized by the driver as one unified area or has a design property. However, both the visible light and infrared light can pass through the indicator film 22 although deteriorated slightly. Instead of the indicator film 22, thin plate-like glass or transparent resin having characteristics similar to those of the indicator film 22 may also be used.

On the indicator film 22, the leftward arrow-shaped area 22a is formed at the position in the Z-axis direction from the indicator light source 19a. Furthermore, the rightward arrow-shaped area 22b is formed at the position in the Z-axis direction from the indicator light source 19b. The leftward arrow-shaped area 22a and the leftward arrow-shaped area 22b are colored in a color different from that of the other area of the indicator film 22. When the indicator light source 19a or 19b emits light, the emitted visible light from the indicator light source 19a or 19b passes through the arrow-shaped area 22a or 22b and is visually recognized by the driver as the arrow-shaped display pattern.

In the example shown in FIG. 3, on the front side of the indicator board 17, the respective components including the indicator light sources 19a and 19b, the camera 15, and the plurality of infrared illumination section 16 are fixed, and the respective components are connected to the circuit patterns on the indicator board 17. Moreover, in the example shown in FIG. 3, on the front side of the meter board 23 constituting the main body of the meter unit 10, the indicator board 17 configured so as to be separated from the meter board 23 is disposed.

As indicated by the arrows shown in FIG. 3, the visible light emitted by the light emission from the indicator light source 19a or 19b passes through the indicator film 22, is directed from the meter unit 10 in the Z-axis direction, and is visually recognized by the driver. Furthermore, the infrared light emitted from the infrared illumination sections 16 passes through the visible light cutting filter 21, also passes through the indicator film 22, and is directed in the Z-axis direction, thereby illuminating the face and the like of the driver. However, since the illumination light of the infrared illumination sections 16 is the light in the infrared light wavelength region, the illumination light is not visually recognized by the driver. The light in the infrared light wavelength region reflected by or radiated from the face and the like of the driver is directed in the reverse direction of the Z-axis, passes through the indicator film 22 and the visible light cutting filter 21, and enters the light receiving face of the camera 15.

### <The Relationship Between the Meter Board 23 and the Indicator Board 17>

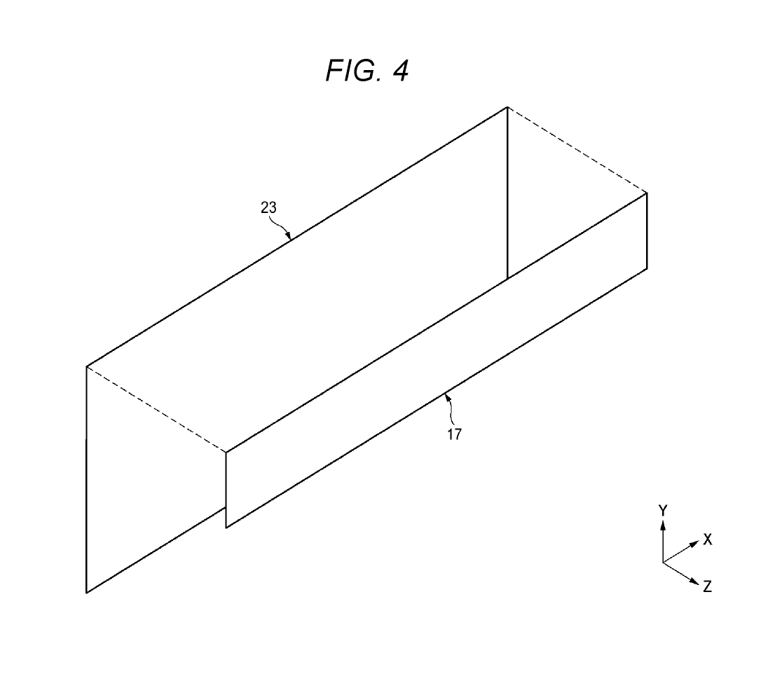

FIG. 4 shows an example of the positional relationship between the meter board 23 and the indicator board 17. In the example shown in FIG. 4, the meter board 23 and the indicator board 17 exist independently of each other.

The meter board 23 is a rectangular circuit board as large as the entire meter unit 10. The meter board 23 has spaces capable of accommodating various components such as the left meter display section 11, the right meter display section 12, the central display section 13 and the indicator display section 14 shown in FIG. 1 and also has circuit patterns for mutually connecting various kinds of circuits.

The dimension of the indicator board 17 shown in FIG. 4 in the X-axis direction is equivalent to that of the meter board 23, and the dimension of the indicator board 17 in the Y-axis direction is smaller than that of the meter board 23. The indicator board 17 is fixed on the front side of the meter board 23, for example, in the state shown in FIG. 4 so as to be opposed to the upper portion of the meter board 23 while a certain clearance is held therebetween, or the indicator board 17 is fixed in a state of being overlaid on the meter board 23.

Hence, as shown in FIG. 1, the indicator board 17 can be disposed as the indicator display section 14 at the upper portion of the meter unit 10. The indicator board 17 has not only the indication function but also the function of the imaging section 18 for photographing the face and the like of the driver.

### <The Positional Relationship Between the On-Vehicle Photographing Device and the Driver>

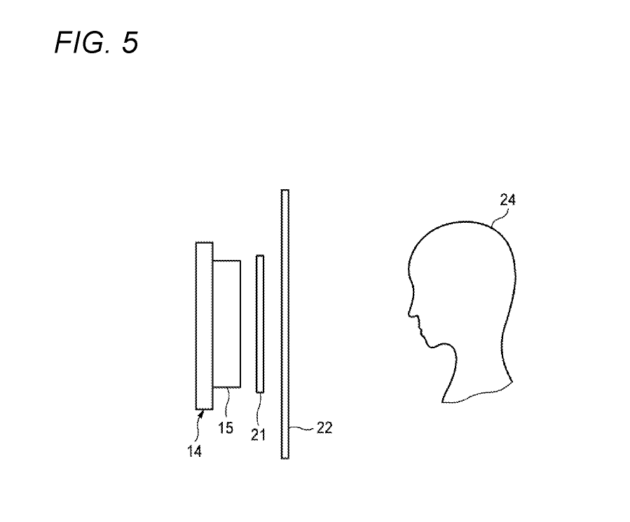

FIG. 5 shows the positional relationship between the indicator display section 14 (on-vehicle photographing device) and the driver 24 of the vehicle as viewed from the side face side of the vehicle.

As shown in FIG. 5, the indicator display section 14 is disposed so as to be opposed to the face and the like of the driver 24. Furthermore, since the camera 15 is built inside the indicator display section 14, the face and the like of the driver 24 can be photographed using the camera 15. Moreover, the driver 24 can visually recognize the display illuminated by the indicator light sources 19a and 19b shown in FIG. 3 on the indicator display section 14.

Since the indicator film 22 being uniform in color and the like is attached to the front face of the indicator display section 14 in a state of covering the entire area of the indicator display section 14, when the driver 24 visually recognizes the indicator display section 14, the driver 24 recognizes the entire indicator display section 14 having the slender rectangular shape as an area having one function.

What's more, since the visible light cutting filter 21 is disposed on the front face of the imaging section 18, the light in the visible light wavelength region representing the images of the outer shapes and the like of the camera 15 and the infrared illumination sections 16 existing behind the filter is shut off by the visible light cutting filter 21 and does not reach the eyes of the driver 24. In other words, the driver 24 cannot visually recognize the shapes of the camera 15 and the infrared illumination section 16.

For this reason, although the indicator display section 14 of the meter unit 10 actually includes the function of displaying the indicators illuminated by the indicator light sources 19a and 19b for example and the function of the imaging section 18, the driver 24 has an illusion that the entire indicator display section 14 is a portion having a function similar to the function of the indicators illuminated by the indicator light sources 19a and 19b. As a result, the driver 24 is unlikely to be aware of the existence of the imaging section 18. Hence, it is possible to monitor the driver 24 using the camera 15 without making the driver 24 conscious of the photographing and monitoring. What's more, since the complicated configuration disclosed in Patent Document 1 is not required, the component cost and manufacturing cost of the on-vehicle photographing device can be reduced.

Since the indicator light sources 19a and 19b are usually turned off, visually recognition is performed as if only the indicator film 22 having the rectangular shape exists in the area of the indicator display section 14 as viewed from the driver 24. When the indicator light source 19a or 19b is turned on during a left or right turn, the driver 24 visually recognizes the arrow-shaped light emission pattern of the indicator light source, thereby believing that the entire area of the indicator film 22 is allocated to display some indicators. As a result, the driver 24 is not aware of the existence of the camera 15.

However, in the case that photographing is performed in the infrared light wavelength region using the camera 15, the infrared illumination sections 16 are required to be installed for illumination so that clear images can be photographed. Nevertheless, in the case that the light emitted from the infrared illumination sections 16 includes visible light wavelength components, when the infrared illumination sections 16 emit light, the driver 24 visually recognizes the light, and this may cause the driver 24 to be aware of the existence of the imaging section 18. However, in the case that the infrared illumination sections 16 are disposed at positions adjacent to or close to such light emission sections as the indicator light sources 19a and 19b as shown in FIGS. 2 and 3, the light from the infrared illumination sections 16 is relatively low in intensity and becomes less conspicuous, whereby the driver 24 does not notice that the light belongs to the imaging section 18.

### <Description of Modifications>

<In the Case that a Camera Board Independent of the Indicator Board is Provided>

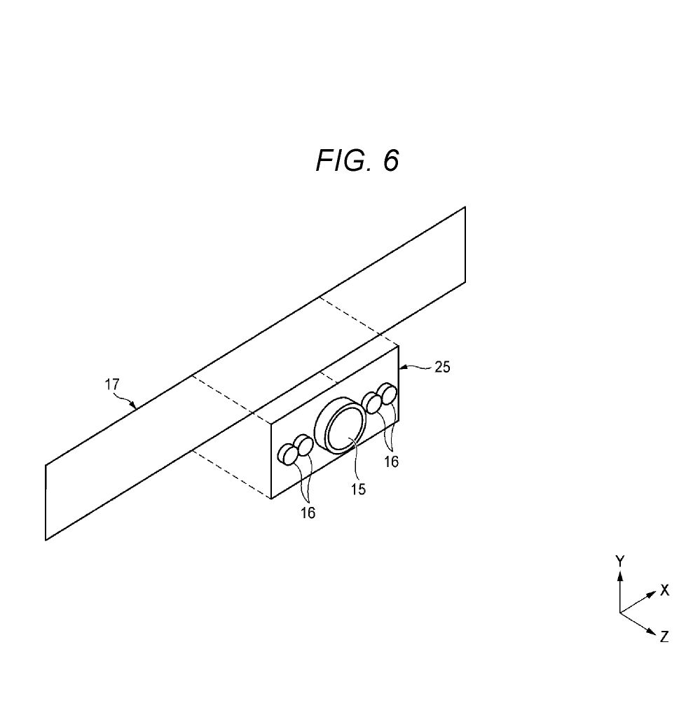

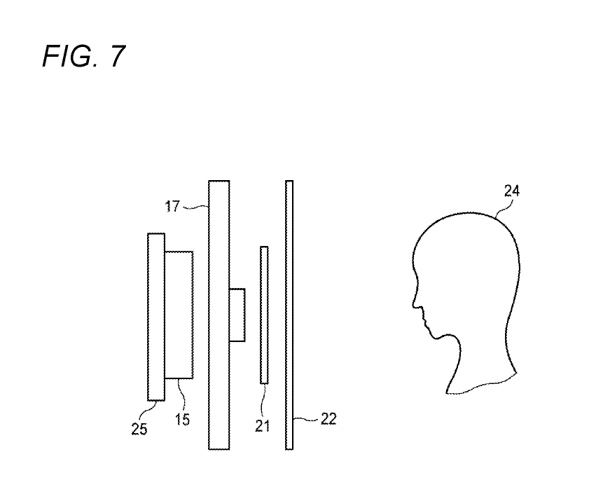

FIG. 6 shows a configuration example in the case that a camera board independent of the indicator board is provided. Furthermore, FIG. 7 shows the positional relationship between the on-vehicle photographing device and the driver in the case that the camera board independent of the indicator board is provided.

In this modification, as shown in FIG. 6, a camera board 25 independent of the above-mentioned indicator board 17 is prepared beforehand, and the camera 15 and the plurality of infrared illumination sections 16 are disposed on this camera board 25. Furthermore, the camera board 25 is disposed so as to be opposed to the nearly central portion in the width direction of the indicator board 17 and is fixed to the indicator board 17. The camera board 25 and the indicator board 17 may be fixed in a state in which a certain clearance is provided therebetween using a predetermined clearance holding member, or the camera board 25 may be overlaid on the indicator board 17.

Moreover, as shown in FIG. 7, the camera board 25 may be disposed behind the indicator board 17. In the case that the camera board 25 is disposed behind the indicator board 17, an opening or a cutout portion, for example, is formed near the central portion of the indicator board 17, whereby the camera 15 and the infrared illumination sections 16 of the camera board 25 are exposed to the face of the indicator board 17 on the side of the driver.

Also in the configuration shown in FIG. 7, the visible light cutting filter 21 is disposed in front of the camera board 25. In addition, the indicator film 22 covering the entire indicator board 17 is disposed nearer to the side of the driver 24 than the visible light cutting filter 21.

Hence, in the configuration shown in FIG. 7, the camera 15 on the camera board 25 can photograph the face and the like of the driver 24 using the light in the infrared light wavelength region passing through the indicator film 22 and the visible light cutting filter 21. Furthermore, since the entire indicator board 17 is covered with the indicator film 22, the driver 24 visually recognizes the entire area of the indicator board 17 as one area having an indicator function. What's more, since the visible light cutting filter 21 is disposed in front of the camera board 25, the shapes of the camera 15 and the infrared illumination section 16 are not visually recognized by the driver 24.

Since the indicator board 17 and the camera board 25 are separated from each other as shown in FIG. 7, these boards are hardly affected by the heat generation from the respective components mounted thereon and can be expected to operate stably.

<In the Case that the Indicator Board is Integrated with the Meter Board>

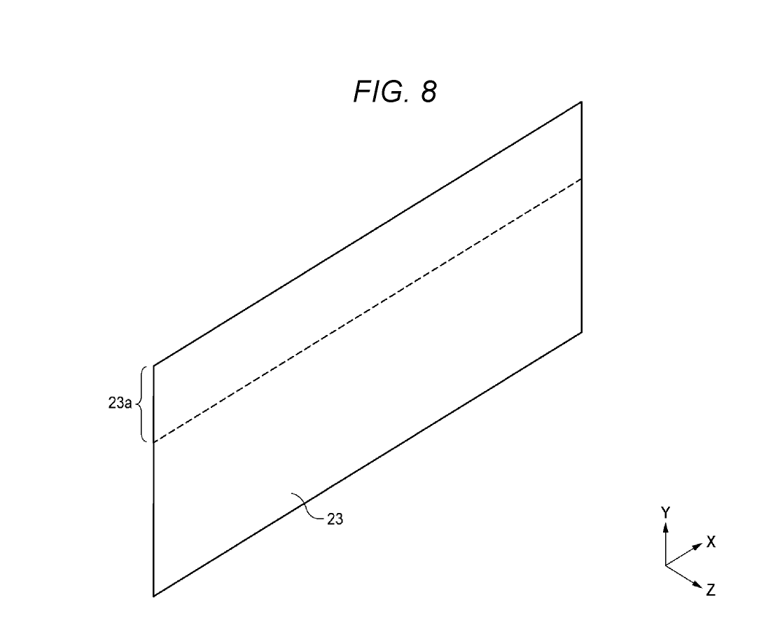

FIG. 8 shows a configuration example in the case that the indicator board is integrated with the meter board. In the configuration shown in FIG. 8, an indicator area 23a is formed at the upper portion of the meter board 23. In other words, the indicator area 23a shown in FIG. 8 can be used instead of the indicator board 17 shown in FIG. 4 and other figures.

In the case of using the configuration shown in FIG. 8, the imaging section 18 shown in FIG. 2 is formed or the camera board 25 shown in FIG. 6 is installed at the nearly central portion in the width direction of the indicator area 23a. Furthermore, the visible light cutting filter 21 is disposed in front of the camera 15 and the infrared illumination sections 16, and the indicator film 22 is disposed so as to cover the entire indicator area 23a.

<Possibilities of Modifications Other than Those Described Above>

In the configuration examples shown in FIG. 1 and other figures, although the infrared illumination sections 16 are installed at positions adjacent to the camera 15 in the configuration examples shown in FIG. 1 and other figures, in the case that the face and the like of the driver 24 serving as a subject can be illuminated from the front side thereof, the infrared illumination sections 16 may be provided at places other than the indicator display section 14.

For example, in the configuration shown in FIG. 6, although the height dimensions of the indicator board 17 and the camera board 25 are almost the same, the dimensions may be changed so as to be different from each other. Furthermore, in the configuration shown in FIG. 6, the positions in the height direction of the indicator board 17 and the camera board 25 may be deviated slightly from each other. However, even in the case that the dimensions and positions of the respective sections are changed as described above, it is preferable that the indicator board 17 and the camera board 25 are entirely covered with the indicator film 22 that is larger than these boards so that the entire indicator display section 14 including the indicator board 17 and the camera board 25 is recognized as one area by the driver 24.

Moreover, in the configuration example shown in FIG. 1, although it is assumed that the indicator display section 14 is disposed inside the meter unit 10, the indicator display section 14 may be disposed outside the meter unit 10, for example, on the dashboard.

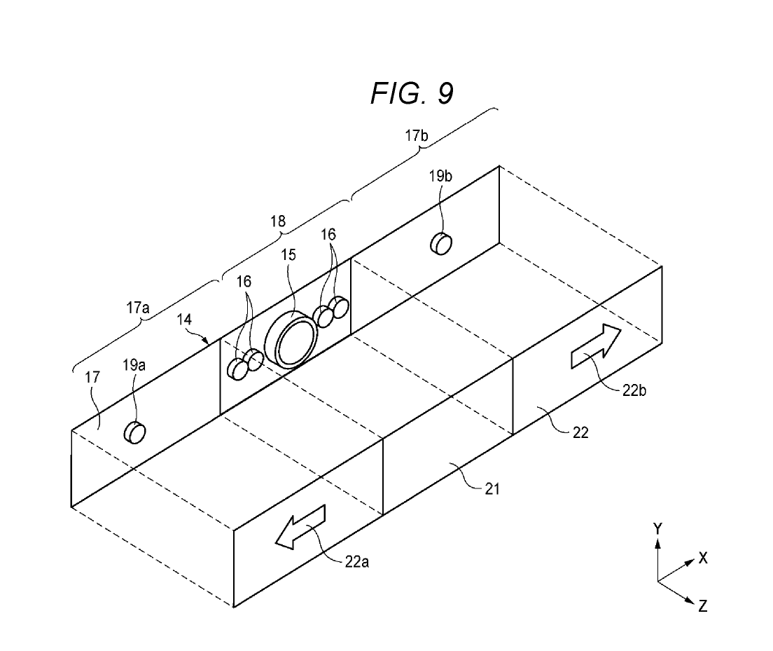

What's more, as shown in FIG. 9, the visible light cutting filter 21 and the indicator film 22 may be integrated with each other. In other words, in the case that the visible light cutting filter 21 and the indicator film 22 are joined and formed into one film, the entire indicator display section 14 is visually recognized by the driver 24 as one unified area as in the configuration example shown in FIG. 2, whereby the driver 24 is unaware of the existence of the camera 15. An area functioning as a visible light cutting filter may be formed in the indicator film 22 instead of joining the visible light cutting filter 21 and the indicator film 22.

The characteristics of the on-vehicle photographing device according to the embodiment of the present invention described above will be briefly summarized and listed in the following items [1] to [3].

[1] An on-vehicle photographing device (indicator display section 14) including a monitoring infrared camera installed inside a vehicle and disposed in a state of being capable of photographing the face of the driver of the vehicle, wherein

the monitoring infrared camera (camera 15) is installed inside a common area (indicator film 22) that is made common to the display area (indicator board 17 and the like) of the indicator (indicator display section 14) which displays the states of the vehicle as viewed from at least the position corresponding to the viewpoint of the driver (driver 24) of the vehicle, and

the monitoring infrared camera is covered with a visible light cutting member (visible light cutting filter 21).

[2] The on-vehicle photographing device set forth in the above-mentioned item [1], wherein

in the common area, the monitoring infrared camera and one or more of the indicators are covered with a common film (indicator film 22) or a common thin plate-like light-conducting member integrally or continuously (see FIGS. 2 and 3).

[3] The on-vehicle photographing device set forth in the above-mentioned item [2], wherein

the visible light cutting member constitutes a portion of the area of the common film or the common thin plate-like light-conducting member (see FIG. 9).

What is claimed is:

1. An on-vehicle photographing device comprising:
a monitoring infrared camera installed inside a vehicle and disposed in a state of being capable of photographing a face of a driver in the vehicle,
wherein the monitoring infrared camera is installed inside a common area that is made common to a display area of an indicator which displays a state of the vehicle as viewed from at least a position corresponding to a viewpoint of the driver in the vehicle, and
the monitoring infrared camera is covered with a visible light cutting member.

2. The on-vehicle photographing device according to claim 1, wherein
in the common area, the monitoring infrared camera and one or more of the indicators are covered with a common film or a common thin plate-like light-conducting member integrally or continuously.

3. The on-vehicle photographing device according to claim 2, wherein
the visible light cutting member constitutes a portion of an area of the common film or a portion of an area of the common thin plate-like light-conducting member.
